(19) United States
(12) Patent Application Publication
(10) Pub. No.: US 2017/0178261 A1
(43) Pub. Date: Jun. 22, 2017

(54) Database And Method Of Use Thereof

(71) Applicant: JAYES Dalia, Modi'in (IL)

(72) Inventor: JAYES Dalia, Modi'in (IL)

(21) Appl. No.: 15/129,831

(22) PCT Filed: Mar. 31, 2015
(86) PCT No.: PCT/IL2015/050336

§ 371 Date: Sep. 28, 2016

Related U.S. Application Data
(60) Provisional application No. 61/975,933, filed on Apr. 7, 2014.
(60) Provisional application No. 62/048,276, filed on Sep. 10, 2014.

(51) Int. Cl. G06Q 50/16; G06Q 30/06; G06F 17/30

(52) U.S. Cl. CPC G06Q 50/16; G06F 17/30283; G06F 17/30241; G06Q 30/0641

(57) ABSTRACT

The present invention provides a searchable network-based database, featuring a plurality of listings of items thrown out and awaiting collection. In addition, the present invention provides a system for providing a network-based database of discarded items, the system including an application server to present listings comprising discarded item/s to users, wherein each listing includes a geographical address for locating the discarded item/s. A listing may include the municipal collection times associated with the geographical location of the discarded item/s in the listing. The present invention further provides a method of creating a network-based database of discarded items and a method of searching the database.

This application claims priority to US Provisional Patent Application No. 61/975,933 filed on Apr. 7, 2014 and US Provisional Patent Application No. 62/048,276 filed on Sep. 10, 2014 and incorporated herein by reference in their entirety.

### FIELD OF THE INVENTION

The present invention relates to a database and a method of use thereof. Moreover, the present invention is of a network-based database.

### BACKGROUND OF THE INVENTION

In our modern society, there is a tendency towards cheaper priced and lower quality goods, which influences the trend of buying new products rather than long-term use of goods, or repairing of broken items. In addition, there is social pressure for having new and latest models of consumer products. These factors have resulted in more items being thrown away, causing an increase of waste. In some countries, items which are not suitable for placing in the regular refuse, such as furniture and electrical goods are placed on the street for pick up by a service such as provided by the local council, municipality or by private collection businesses. In certain countries, the collection method is inefficient, as without the locations of waste of this kind, collection trucks needlessly drive through streets which have no waste to collect. Once collected, a number of different methods may be used to deal with this waste, such as incineration, landfilling and recycling.

The proliferation of waste is a global environmental concern and its reduction a global objective. One solution is reuse of the waste. There are several ways in which reuse of household items can be realized. One option is for an owner to sell his used items. Alternatively, an owner can donate or give away his used items. He may advertise the items for giving away by for example using freecycling sites or mailing lists, whereby the owner advertises the article and arranges with an interested party when to pick it up from his address. Disadvantages of these methods are the need to disclose and give access to your address to strangers, the inconvenience of having to arrange for someone to be at the address for item pick up and the necessity of storing the items. As a result of these problems, usable items are often thrown out instead of being redistributed for reuse.

There is a demand by individuals for free, used and/or discarded products, for environmental, financial, political and artistic reasons among others. However, a person who would like to obtain discarded items must rely on chance to find a product he wants discarded on the street. Additional shortcomings of searching the streets are the length of time involved and the possibility of not finding the desired product. Such an individual may use the aforementioned freecycling sites or mailing lists to locate a particular product. However, these options may restrict the individual to a preordained time set by the owner of when to collect the item. In addition, the lack of anonymity involved may cause embarrassment to someone seeking used products out of financial necessity.

There is a window of time from when an item is discarded by an owner until it is picked up by a refuse collection service. Although there may be recycling and reuse solutions for items before they are thrown out by a user, there are no suitable solutions available for facilitating locating and reuse of items after they have been discarded and before they have been collected by a rubbish pick up service.

It would therefore be desirable to have a system and method for facile locating of discarded items. It would be beneficial to have a method of facilitating reuse of unwanted items without the need to wait for other parties in order to collect the items. It would also be advantageous to be able to estimate whether the discarded items have been collected. It would further be beneficial to have a solution for reuse of items after they have been discarded and before they have been collected by a collection service. The present invention provides such a system, method and uses thereof.

### SUMMARY

The invention may have several aspects. One aspect is a searchable network-based database, featuring a plurality of listings of items thrown out and awaiting collection. The items may not be in a bin. The listings may include an image of the item and a location of the item. The plurality of listings may be uploaded by a plurality of users at a plurality of locations. The database may be provided by a system including an application server associated with a plurality of communication devices to present the listings featuring thrown out item/s to users. The application server may be configured to receive from a plurality of communication devices listings of thrown out items and the respective geographical address for locating the thrown out items. The application server may be configured to determine when the pickup collection times of a thrown out item by a collection service are, according to the geographical address of the thrown out item. The application server may be configured to display with the listing the determined collection times. The determined collection times may be the next collection day relative to the date and time the thrown out item is uploaded onto the database. The database may be configured to enable a user to search and view the listings of thrown out items and to obtain location information of the items to facilitate the user locating the items. The items may be at least one of household items, bulky items, furniture, cupboards, tables, chairs, sofas, beds, desks, shelves, fences, mattresses, fridges, ovens, gas burners, washing machines, dryers, dishwashers, sinks, toilets, doors, umbrellas, clothes horses, baskets, books, clothes, crockery, cutlery, bicycles, scooters, games, tents, swings, toys, appliances, electrical devices, electronic devices, office furniture, office equipment, computers, printers, televisions, paintings, art, telephones, radios, heaters, carpets, flooring, baths, taps, gardening accessories, paint, mirrors, wood, metal, household items, home fixtures, sports equipment, gardening items and plants.

An aspect is a system for providing a network-based database of discarded items. The system may include an application server to present listings featuring discarded item/s to users. Each listing may include a geographical address for locating the discarded item/s. Each listing may include the municipal or other collection times associated with the geographical location of the listing.

In various embodiments, the application server may be associated with a plurality of communication devices. The application server may be configured to receive from the plurality of communication devices listings of discarded items and the respective geographical address for locating the discarded items. The application server may be configured to determine when the pickup collection times are according to the geographical address of the discarded item and the application server may be configured to display with the listing the determined collection times. The determined collection times may be the next collection day relative to the date and time the discarded item is uploaded onto the database. The listings may be uploaded by at least one user. The listings may comprise a photograph of the item and a location of the item. The listings may include at least one of a state or condition of the item, the number of same items, the availability status, a description of the item, the number of people interested in the item and directions to the item. The system may be configured to enable a requesting user to view the listings of discarded items. The application server may be configured to enable a requesting user to search the listings according to a geographical region. The application server may be configured to enable a requesting user to search the listings according to a distance or radius from the location of the user or from a location selected and/or defined by a user. The system may be configured to enable a requesting user to search the listings for an item defined by the user and to display the defined item/s identified in the listings.

An additional aspect is a computer readable storage medium having computer readable instructions thereon for managing information relating to discarded items over a network. The computer reader instructions may cause a computing device to perform actions, including transferring a request to view listings of discarded items associated with a parameter, such as, but not limited to a geographical area, a category of items, a specific item, availability and a combination thereof and enabling a requesting user to view listings of discarded items. The actions may include determining the municipal collection times relating to the location of an item in the listings and enabling the user to view the determined municipal collection time. In various embodiments, the actions may include displaying to a requesting user the next collection time of an item relative to the date and time the item listing was uploaded to the database.

Another aspect is a method of verifying that a thrown out item has been taken. The method may include a user confirming that an item is at a location. The method may include a user deciding to take the item. The method may include comparing the temporary GPS location of the thrown out item with the GPS location of the mobile device of a user taking the thrown out item when at the temporary location of the thrown out item. The method may include verifying that the GPS location of the item is substantially the same as the GPS location of the user taking the item. The comparing the temporary GPS location of the thrown out item with the GPS location of the mobile device of a user taking the thrown out item may be initiated by the user using his mobile device for selecting that an item is taken. The selecting may employ a computer module of a searchable network-based database of listings of items thrown out for collection by a collection service and awaiting collection. The listings may include an image of the item and a location of the item. The GPS location of the thrown out item may be determined by the GPS location of a user device of a user throwing out the item at the time of uploading the listing. The GPS location of the thrown out item may change after the item has been taken.

A further aspect is a system for providing a network-based database of discarded goods with verification when a user has taken a discarded good. The system may include an application server associated with a plurality of communication devices. The application server may be configured to receive from the plurality of communication devices listings of discarded goods and the respective geographical address for locating the discarded goods. The application server may be configured to receive from a communication device of a person seeking at least one of the discarded goods the GPS address of the seeking user at the location of the at least one discarded goods. The application server may be configured to determine that the geographical address for locating the discarded goods is substantially the same as the seeking user's geographical address. The application server may be configured to display with the listing that the discarded good has been taken when the geographical address of the discarded goods is substantially the same as the geographical address of the seeking user. The geographical address for locating a discarded good may be the GPS location of the communication device used to upload the listing at the time the listing was uploaded.

Another aspect is a method of creating a searchable network-based database of discarded items. The method may include a user uploading a listing. The uploading may include entering a program of the network-based database using a communication device and selecting an uploading item option. The uploading may include uploading a photograph of the item. The method may include an application server providing information to the database relating to the item listing. The providing information may include receiving the GPS address of the user device at or in close proximity to the location where the item is discarded and displaying the address as the item address. The providing information may include calculating and displaying a date and time of the uploading. The application server providing information to the database may include calculating a collection time of the item according to the location of the item and displaying the next collection time according to the date the item listing is uploaded.

In various embodiments, uploading may include selecting a photograph option and uploading a photograph of the item. The uploading may include selecting a location option and uploading a location of the item. The uploading may include the user and/or the program calculating and displaying a date and time of uploading the item, calculating a collection time of the item according to the location of the item and displaying the next collection time according to the date the item is uploaded.

In various embodiments, the method may further feature selecting from a menu option, at least one of the following: a number of same items option and entering the number of same items, a description option and entering a description of the item and a state option and entering the state of the item. The method may include calculating and storing with the listing the GPS coordinates of the uploaded listed item. The method may include saving the listing to the database and repeating the method by a plurality of users. The method may include displaying the item is unavailable after the next collection time has elapsed and/or displaying the item is unavailable after the item is taken. The method may be employed by a user, a computer program or a combination thereof. The method may be repeated by a plurality of users at a plurality of locations.

A still further aspect is a method of a user searching for a discarded item using a searchable network-based database. The method may include entering a program of the network-based database using a communication device. The method may include selecting an option to search for a discarded item. The method may include selecting a search item. The method may include searching according to a geographical region. The method may include viewing the displayed listings of items. The searching may be done by a user, by a computer program or by a combination thereof.

In various embodiments, the method may include checking the availability status of the item. The method may include checking the next collection date and/or time according to the location of the item and determining the item is available. The method may include locating the item according to the location information of the listing and selecting the no longer available option. The method may include a program calculating a GPS location of the user; comparing the GPS location of the user searching for a discarded item (searching user) with a GPS stored location of the discarded item and displaying verification that the item has been taken when the GPS location of the searching user and the GPS location of the discarded item are substantially the same.

An additional aspect is a method of obtaining abandoned property. The method may include at least one user abandoning at least one piece of property into a space for collection. The method may include at least one first user uploading details of the piece of abandoned property to a searchable network-based database. The method may feature a second user searching the database for an item of abandoned property, the second user obtaining from the database location details of an item of abandoned property listed in the database and the second user locating the item of abandoned property at the listed location. The method may include the second user taking the abandoned property.

A further aspect is a method of a user throwing out at least one item, featuring the user throwing out an item into a space for collection and the user uploading details of the thrown out at least one item to a listing in a searchable network-based database. The space for collection may be outside.

A still further aspect is a method of finding at least one thrown out item featuring a user searching a network-based database of thrown out items, the user obtaining from the database location details of an item listed in the database and the user locating the thrown out item at or near about the listed location.

An aspect is a system for collecting rubbish by a collection service provider. The system may include an application server associated with a plurality of communication devices. The application server may be configured to receive from the plurality of communication devices listings of discarded goods and the respective geographical addresses for locating the discarded goods. The discarded goods may not be in a bin. The application server may be configured to receive updates regarding the availability of the listings of discarded goods. The application server may be configured to present the plurality of locations of the discarded goods to a rubbish collection service provider. The application server may be configured to present to the rubbish collection service provider after a defined time before collection the plurality of locations of the discarded goods, which are displayed as available at the defined time before collection. The locations of the discarded goods may be provided on a map.

An additional aspect is a method of collecting thrown out items, featuring locating and collecting thrown out items according to a map. The map may include location details of the thrown out items from listings of the thrown out items uploaded by a plurality of users to a searchable network-based database of thrown out items. The method may include creating a map of the plurality of locations of the plurality of thrown out items, wherein the plurality of locations are within a defined area and the plurality of thrown out items are not in bin. The creating the map may be done after a predetermined time. The plurality of locations and the plurality of thrown out items may be from listings of thrown out items displayed as available at or after the predetermined time. The collecting of the thrown out items may be done by at least one collection vehicle.

A further aspect is a map of locations of thrown out items for collection. The locations of the items may be determined according to listings of the items uploaded by at least one user to a searchable network-based database. The thrown out items may be outside and may not be in bins. The thrown out items may be displayed as available in the listings. The map may include at least one of roads, streets and landmarks and wherein the landmarks may include at least one of benches, schools, parks, shops, shopping centers, offices, streetlamps, rubbish bins, universities, libraries, cinemas, theatres, gyms, swimming pools, tennis courts, basketball courts, football fields, synagogues, churches, mosques, cemeteries, ice skating rinks, museums, hospitals, surgeries, postboxes, parking lots, bus stops and stations.

A still further aspect is a route for a waste collection vehicle, featuring a combination of roads to facilitate access to collect a plurality of thrown out items at a plurality of locations. The route may be determined according to a map of the plurality of locations of the thrown out items for collection, wherein the plurality of locations of the thrown out items are determined according to listings of the thrown out items uploaded by at least one user to a searchable network-based database, which may be displayed as available at or after a defined time. The route may facilitate access to the items at locations included in the listings. The route may be at least one of the quickest route and the shortest distance route. The route may be determined according to at least one of the number of available or the minimal number of collection vehicles, workers and work hours. The locations of the items may be determined according to listings of the items, which are displayed as available at or after a defined time.

### BRIEF DESCRIPTION OF THE DRAWINGS

The various features of the invention will best be appreciated by simultaneous reference to the description which follows and the accompanying drawings and in which:

FIG. 1 shows a schematic representation of an exemplary application according to an aspect of the present invention;

FIG. 2 shows a flow diagram of an exemplary method of creating a database of listings of discarded items according to an aspect of the present invention;

FIG. 3 is a schematic representation of an exemplary registering according to an aspect of the present invention;

FIG. 4 is a schematic representation of an exemplary uploading an item according to an aspect of the present invention;

FIG. 5 is an exemplary method of uploading a photograph of an item according to an aspect of the present invention;

FIG. 6a is a flow chart of an exemplary method of describing an item according to an aspect of the present invention;

FIG. 6b is an exemplary representation of an item description according to an aspect of the present invention;

FIG. 7a is an exemplary method of uploading the state of an item according to an aspect of the present invention;

FIG. 7b is a schematic representation of an exemplary display of the state of an item according to an aspect of the present invention;

FIG. 8a is an exemplary method of uploading the number of items according to an aspect of the present invention;

FIG. 8b is a schematic representation of an exemplary number of items option according to an aspect of the present invention;

FIG. 9a is a flow diagram of an exemplary method of uploading a location according to an aspect of the present invention;

FIG. 9b is a schematic representation of an exemplary display of the location of an item according to an aspect of the present invention;

FIG. 10 is a schematic representation of an exemplary display of the time and date an item is uploaded according to an aspect of the present invention;

FIG. 11a is of an exemplary method of creating a database of items with collection times according to an aspect of the present invention;

FIG. 11b is an exemplary method of creating a database with collection times in accordance with an aspect of the present invention;

FIG. 11c is a schematic representation of an exemplary display of a listing with a collection time according to an aspect of the present invention;

FIGS. 12a, 12b, 12c are schematic representations of exemplary displays of listings according to aspects of the present invention;

FIG. 13 shows a flow diagram of an exemplary method of displaying listings of discarded items to a user searching for an item in a database according to an aspect of the present invention;

FIG. 14a is an exemplary method of searching for a region according to an aspect of the present invention;

FIG. 14b is an exemplary method of searching according to an aspect of the present invention;

FIG. 15 is an exemplary method of a user searching a database for a discarded item according to an aspect of the present invention;

FIG. 16 is an exemplary method of verifying that a user has picked up a discarded item according to an aspect of the present invention;

FIG. 17 is an exemplary system for providing a database according to an aspect of the present invention;

FIG. 18 shows a flow diagram of an exemplary method of uploading a listing of an item according to an aspect of the present invention;

FIG. 19 shows an exemplary method of discarding an item according to an aspect of the present invention;

FIG. 20 shows an exemplary method of finding at least one thrown out item according to an aspect of the present invention;

FIG. 21 shows an exemplary method of obtaining abandoned property according to an aspect of the present invention;

FIG. 22 shows an exemplary method of use of the database of the present invention according to an aspect of the present invention;

FIG. 23 shows an exemplary system for providing a user, such as a collection service provider with a plurality of locations of items to collect according to an aspect of the present invention;

FIG. 24 shows an exemplary map of locations of items for collection according to an aspect of the present invention; and

FIG. 25 shows an exemplary route for a waste collection vehicle, according to an aspect of the present invention.

### DETAILED DESCRIPTION

In one aspect the present invention is of a network-based database of discarded goods, which may be searchable and a system for providing a user with such a database. The database may include listings of goods which have been discarded. The discarded items may be awaiting collection, such as for example by a collection service. The thrown out items may not be in a bin. The listings may be uploaded to the database by the discarders of the items or others. The network-based database may be employed by a user seeking an item, whereby a person and/or computer program may search the database for such an item. The system may include an application server to present listings featuring discarded items to users. The listings may include data, such as information relating to the item. The information may include, but is not limited to information describing the item, information relating to the location of the item and information relating to the availability of the item. Information may include images. Each listing may include municipal or other collection service provider times associated with the location of the listing. The application server may be associated with a plurality of communication devices. The server may receive from users via the plurality of communication devices listings of discarded items. In an aspect the present invention is of a method of creating a searchable network-based database of discarded items. The method may include at least one user uploading a listing.

In a further aspect the present invention is of a network-based database of thrown out items, which displays the next collection time of an item, wherein the next collection time is calculated by the system of the present invention. The next collection time may be automatically calculated according to at least one of the item location, date of uploading and time of uploading.

In an aspect the present invention provides a system and a method which determines if the discarded item has been taken. The system may verify when a user has taken an item. The availability of the item may be displayed with the listing.

In a still further aspect the present invention is of a method of searching and/or viewing listings of discarded items. The method may include viewing the next relevant municipal or other collection times.

In another aspect the present invention is of a method of obtaining abandoned property.

An additional aspect of the present invention is of a method of a user throwing out at least one item. A user may throw out at least one item into a space for collection and the user may upload details of the item to a listing in a searchable network-based database.

An aspect is a method of finding at least one thrown out item using a searchable network-based database of thrown out items.

An aspect of the present invention is a system for a collection service provider to collect rubbish. The system may include an application server associated with a plurality of communication devices. The application server may be configured to receive from the plurality of communication devices listings of discarded goods and the respective geographical address for locating the discarded goods. The application server may be configured to present the plurality of locations of the discarded goods to a rubbish collection service provider.

An additional aspect is a method of collecting rubbish, featuring locating and collecting rubbish according to a map. The map may include location details of the thrown out items for collection, wherein details of the items are uploaded by at least one user to a searchable network-based database.

A further aspect is a map of locations of items for collection. The locations of the items may be determined according to details of the items uploaded by at least one user to a network-based database.

A still further aspect is a route for a waste collection vehicle, determined according to a map of locations of thrown out items for collection, wherein the locations of the items are determined according to listings uploaded by at least one user to a network-based database. The route may facilitate access to the items at locations included in the listings.

The systems, applications, databases and methods of the present invention provide an organized way for a person/s to find items, which have been thrown out by an owner or other user. Previously, a user searching for an item discarded and placed out onto the street would have to embark on a time consuming search of the streets, without the certainty of the availability of a particular item, such as whether it had even been thrown out in the geographic area being searched. The present invention is a more time efficient search method wherein a user can identify whether a certain item is available in a geographical area. In addition, a user may be notified of when such an item will be collected by a collection service, or whether it has been picked up by another person. The systems, applications, databases and methods of the present invention are relatively facile to use.

Furthermore, the systems, applications, databases and methods of the present invention provide an organized and time efficient way for a waste collection service provider to collect items, such as items not in a bin and/or associated with a bin, which have been discarded onto the street. The present invention identifies which streets and where on the streets the collection service needs to go to, preventing needless driving down streets where there are no waste items to pick up.

As used herein the term ‘discarded’ may include, but is not limited to thrown out, thrown out of a property, placed so that it is no longer possessed, abandoned property, disposed of into a public area, disposed of into a collection space, an ownership state such that the item can be freely taken by another party, got rid of, disowned, put in the rubbish, put out on the street, put outside, put outside a property or a house or building and placed for collection.

As used herein the term ‘user’ may include, but is not limited to a person, a computer or an institution searching for an item. The user may be the person who wants to use and obtain the item or may be a person doing the searching for use or possession of the item by another person. A user may be a search engine. A user may also include a person/s, a computer or an institution throwing out an item/s. The user may be the owner of the item or may be a person or institution who does not own the item. A user may include a person or institution collecting data and/or using data from the systems, applications and methods of the present invention. A user may be one or more than one person.

As used herein the term ‘thrower’ may include, but is not limited to a user who owned an item, which he is discarding or has discarded and an individual physically putting out an item, which is owned by another individual. The term may be used in relation to the throwing of the discarded item/s in question.

As used herein the term ‘searcher’ or ‘searching user’ or ‘seeking user’ may include, but is not limited to a user/s who is searching for an item.

As used herein the term ‘item’ may include, but is not limited to any article or goods which can be thrown out or discarded and which can be reused. The item may be reused in its entirety or parts of the item may be reused. The item or part/s of the item may be reused for the same original use or may be reused for a different use.

As used herein the term ‘non-regular waste’ may include, but is not limited to, rubbish which is not considered regular rubbish by a cities rubbish pick up service. It may include recyclable and reusable waste and items. It may include articles, which are too bulky, big and/or too heavy to be put in the regular bins. It may include any items which are not binned or associated with a bin. It may include waste, which is thrown out less frequently than regular waste. It may also include furniture, electrical goods, electronic goods and equipment. It may also include suitable articles, which can be reused, and which may be included in regular waste such as, but not limited to clothing and books.

As used herein the term ‘collection space’ may include, but is not limited to a space, which deems an item placed there as identifiable as a thrown out item for collection. Non limiting examples of collection spaces include next to or in the vicinity of a rubbish container, a rubbish bin enclosure or room, a tip, the street, the sidewalk, outside a property, the road, the curb and a combination thereof.

As used herein the term ‘collection service provider’ may include, but is not limited to the municipality, council, government or equivalent, a municipality/council chosen company for waste collection, a municipality/council/government run collection service and a private waste collection service.

The principles and operation of systems, databases, applications and methods according to the present invention may be better understood with reference to the figures. The figures show non-limiting aspects of the present invention.

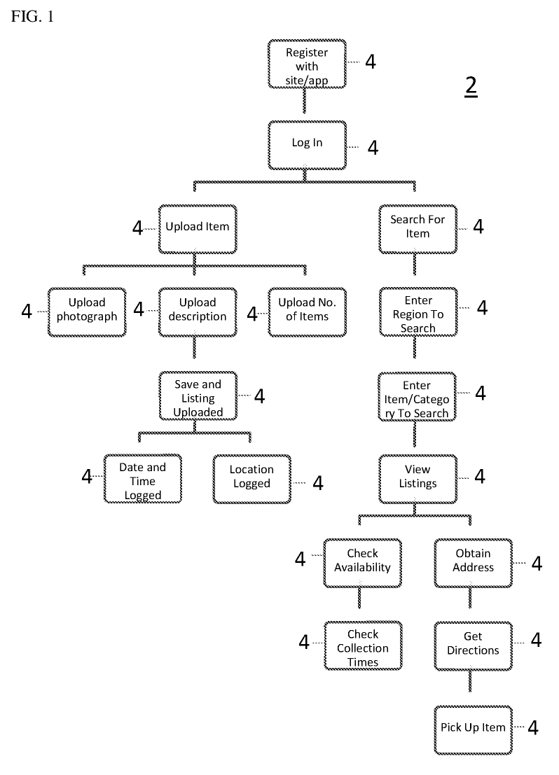

FIG. 1 shows a schematic representation of an exemplary program/application 2 according to an aspect of the present invention. The program/application 2 may be used to create a database of thrown out items or to search the database for a thrown out item. As can be seen in FIG. 1, the application/program 2 may include a plurality of selection modules and features 4. These features 4 may be automatic, manual, may require selection or may require any suitable input by a user. The program/application 2 may be configured to provide suitable modules 4 for creating a user searchable database of thrown out items. The modules and features 4 may be provided separately or in any suitable combination and may employ any suitable design. Non-limiting examples of suitable modules 4 include a module for registering, a module for logging in, an item upload module, a photo module, a description module, a number of items module, a listing upload module, a date and time module, a location module, a search module, a search by region module, a search by category module, a module to view listings, an availability module, an obtain address module, a collection times module, a directions module and an item is taken module. The program/application, the systems incorporating the program, the database, the modules and features and the methods of use will be further explained herein.

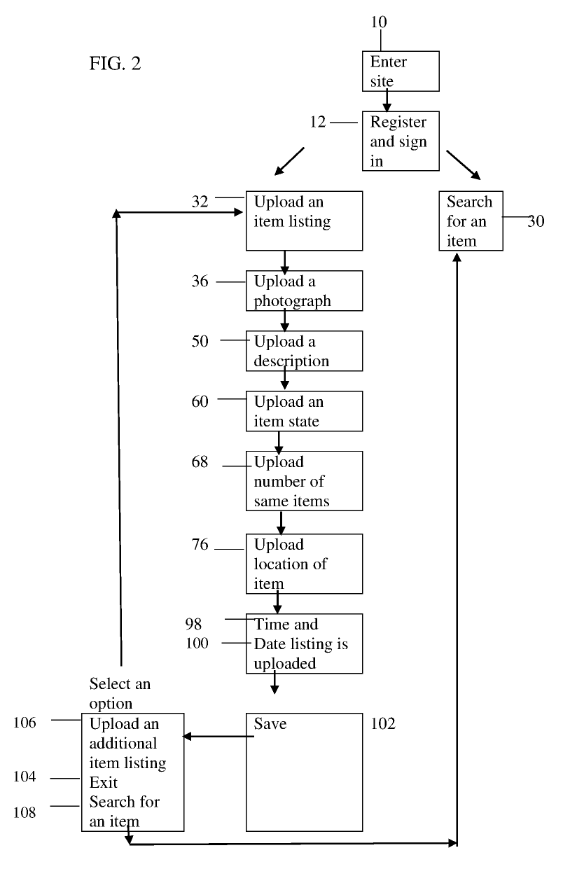

FIG. 2 shows a flow diagram of an exemplary method of creating a database, such as a network-based database of listings of discarded items according to an aspect of the present invention. The database may include a plurality of listings of discarded items, which may be uploaded by a plurality of users at a plurality of locations. The discarded items may be items, which are thrown out and which are not in a bin. The discarded items may be items which are thrown out in a suitable place for collection by a collection service, such as the municipality waste collection service. The listings may be uploaded by users. A user may be any suitable user and may include, but is not limited to the owner of an item to be discarded, a person discarding an item, a shop or company discarding an item, a person identifying a discarded item, a computer discarding an item, a registered member or a visitor to the site or application. As shown in FIG. 2, a user may enter the program/application of the present invention 10. The program/application may be available on a computing device, such as a desktop computer, a laptop computer, a mobile device, a cellular phone, a tablet or any other suitable device. The program may be available via an internet site or by a mobile or communication application, such as but not limited to an android compatible application and an Apple® iOS compatible application. A user may enter the program/application by any suitable means, such as by downloading the application or accessing the site by for example using the site's internet address.

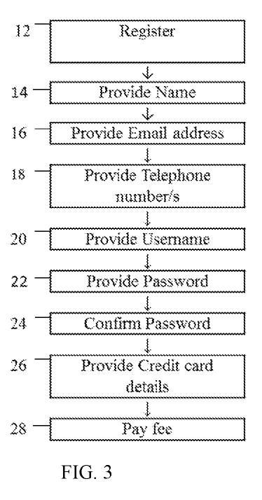

In some embodiments, the user may register with the site or application 12. When a user has previously registered, a user may enter the site or application by signing in/logging in using sign in details such as, but not limited to a username and a password. A registered user may not need to sign in when using the application. In some embodiments, a user may not need to register or may use the application as a visitor. FIG. 3 shows an exemplary schematic representation of registering 12 according to an aspect of the present invention. Registration may include providing user details to a registration module. Details may include, but are not limited to providing the name of the user 14, providing an Email address 16, providing the user's contact telephone numbers 18, providing a username 20, setting a password, which may include providing a password 22, and confirming the password 24 and providing the user's credit card or other payment details 26. A mailing address may also be requested, which the user may provide. In some embodiments the user may pay a fee 28 to register. Registration may be subject to a fee or may be cost free. In some embodiments a fee may provide a user with a higher status. The higher status may provide a user with advantages, such as discounts and access to a premium application with more features and/or more advanced features. A user may pay a fee, the amount of which may determine the area of search. The area of search may be for example, but not limited to geographical area, or number and types of category of items. A fee may provide a user with notification or early notification of a new and/or specific uploaded item listing. A non-paying user may only have access to a reduced geographical area of search and or a reduced type of item search and/or a reduced number of searches per month.

In some embodiments, registration may include a user providing a name, an Email address, a cellphone number and a password. Confirmation of registration may be sent to a user by Email or by messaging to a user's mobile phone.

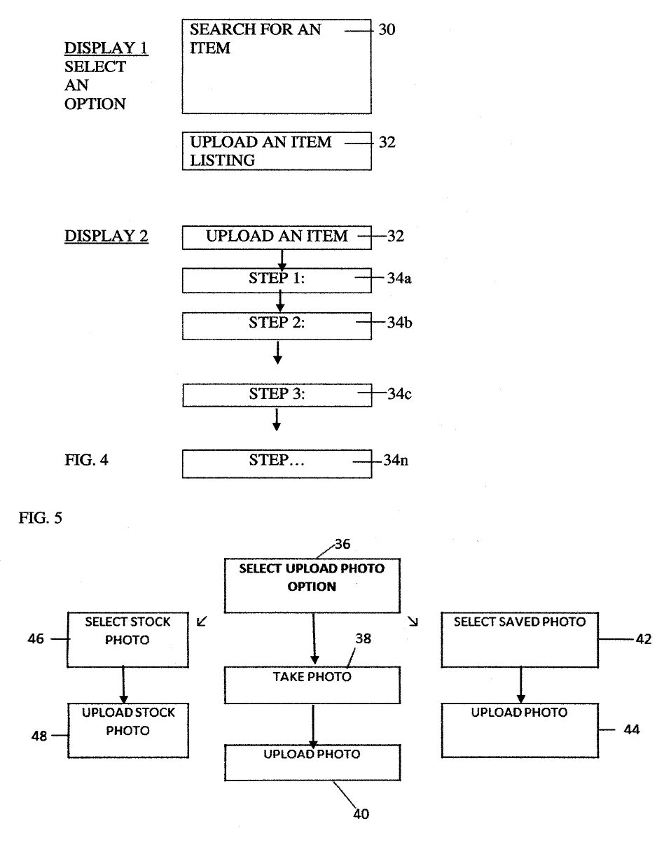

When the user enters the program/application, the user may arrive at a landing page. The landing page may include plurality of options and/or a menu with a plurality of options. The graphic user interface (GUI) may provide the user with the option of a search module for searching for an item 30 or an item submission/throwing module for uploading a listing of a thrown item 32. A user who is throwing out at least one item or a user who wants to add to the database an item/s thrown out by someone else, may select the uploading an item listing option 32 as shown in FIG. 4. The user may follow a plurality of steps 34 in order to upload a listing of an item.

The GUI may provide the user with a picture module for the option of uploading a photograph of the item 36 as shown in FIG. 5. The user may take a picture 38 with a camera and upload it 40. The camera may be a feature or part of the program or application of the present invention or the photograph may be taken using any suitable camera. In some embodiments a camera on a cellular phone may be used and the camera may include the option of uploading the photograph to the database of the application or program of the present invention. In some embodiments a user may select the option of using a previously taken and saved photograph of the item 42 and upload this photograph 44. The photographs may be in color or black and white. In some embodiments a user may select a photograph of a similar item from a gallery of photographs, which may be provided in the database 46 and the user may upload the stock photo 48. A user may upload a listing without a photograph. In some embodiments, the program may provide and display a picture according to a description of the item.

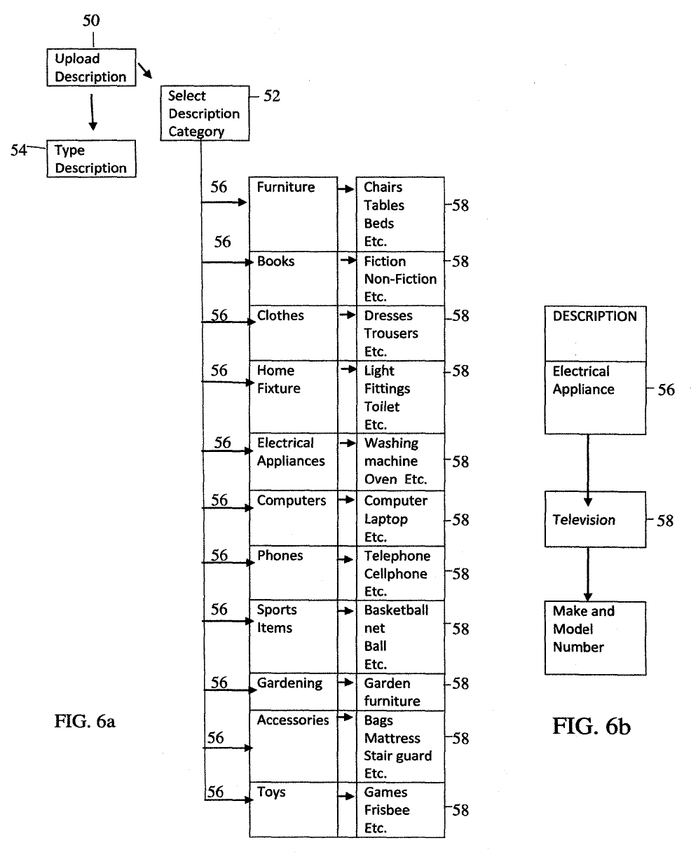

The GUI may provide the user with an item description module for the option of uploading a description of the discarded item 50. FIG. 6a is a flow chart of an exemplary method of describing an item. As shown in FIG. 6a the user may select description options from a list provided by the GUI 52, or may input an independent description 54. The GUI may provide a menu of categories 56 such as, but not limited to furniture, home fixtures, electrical appliances, computers, cellular phones, sports items, gardening items, gardening waste, clothes, accessories, books, building materials, packaging and toys. When a user selects a category 56, the user may be provided with subcategories 58. For example subcategories of computers may include laptops and tablets. A user may then select at least one of the subcategories. A user may select more than one category and subcategory to describe an item. Alternatively, or in addition a user may input his own description of the item 54 by for example typing in a description. In some non-limiting examples, the program or application of the present invention may automatically describe the item based on the uploaded photograph. The program or application of the present invention may use the description, such as the categories and subcategories to group the listings. Such a category grouping of the listings may help a user search for an item associated with a certain group. FIG. 6b shows an exemplary representation of an item description according to an aspect of the present invention. As shown in FIG. 6b, the description may include at least one category 56 and at least one subcategory 58 to which the discarded item belongs.

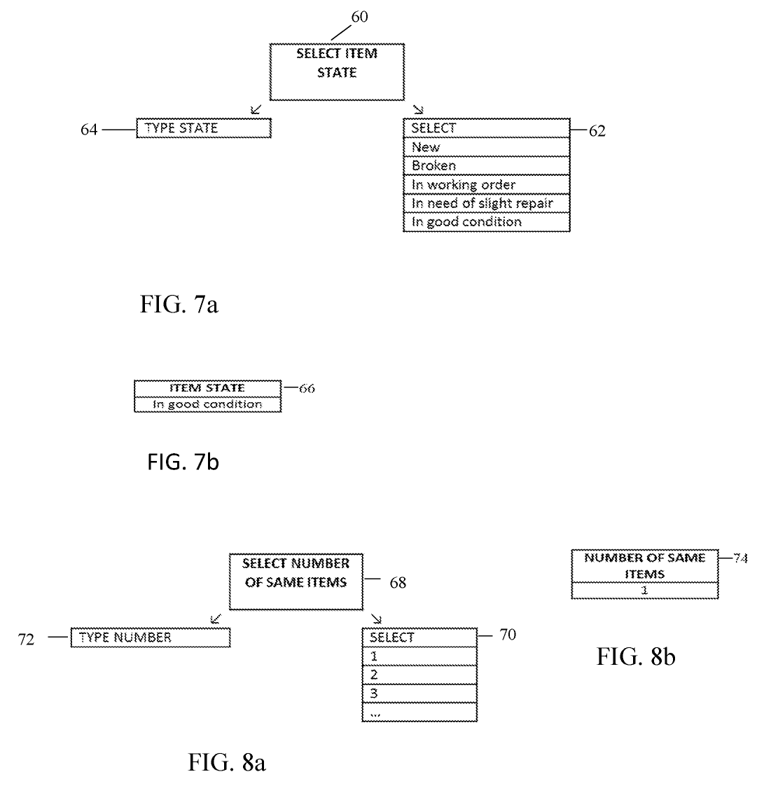

The GUI may provide the user with a state module for the option of uploading a state or condition of the discarded item 60. FIG. 7a shows an exemplary method of uploading the state of a discarded item according to an aspect of the present invention. As shown in FIG. 7a the user may select options from a list provided by the GUI 62 such as, but not limited to new, broken, in working order, in need of slight repair and in good condition. Alternatively, or in addition a user may input the state of the discarded item 64, by for example typing in a description of the state of the item. The state of the discarded item may be displayed with the listing. FIG. 7b shows an exemplary schematic representation of the display of the state of an item 66 according to an aspect of the present invention. The example shows the state of the item as in good condition.

The GUI may provide the user with a number of items module for the option of selecting the number of same items which are being discarded 68. FIG. 8a is an exemplary method of uploading the number of same items by a user. A user may discard one or more than one of the same item. For example a user may throw out several chairs. As shown in FIG. 8a the user may select a number from options displayed on the GUI 70 or may input a number 72, by for example typing a number in the option space. The number of same items 74 may be displayed as shown in FIG. 8b. The number of same items may be displayed with the listing. The example shown in FIG. 8b shows a listing which includes one same item.

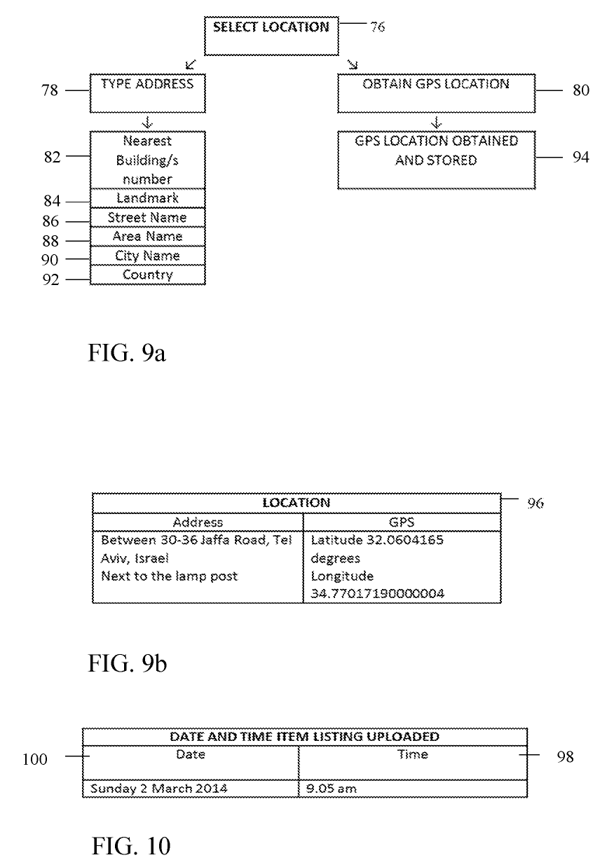

The GUI may provide the user with an item location module for the option of uploading the location of the discarded item 76. The location may be used for finding the discarded item. FIG. 9a shows an exemplary method of uploading the location of a discarded item. As shown in FIG. 9a, the user is provided with an option of inputting an address 78 and an option of obtaining the GPS location 80. A user may select to input an address 78. The user may input the address and may input some or all of the number/s of the nearest building/s 82, a landmark 84, a street name/s 86, an area name 88, a city name 90 and a country name 92. The address may be a specific address of outside or near a building or house. The address may include several buildings or houses in an example where the discarded items are outside more than one house or building. A user may prefer to include an address, which is not specific to one house or building in order to conceal his home or whereabouts. The address may include hints of where the item is located relating to landmarks, such as, but not limited to at least one of on the street, in the road or next to a streetlamp. Alternatively, or in addition, the user may select an option which calculates the GPS location of the discarded item 80. The GPS location may be determined using any suitable program, such as, but not limited to Google Earth. Using a suitable device with the program or application of the present invention, the GPS option may be selected at the place where the item has been discarded in order to correctly determine the GPS coordinates of the item. In a non-limiting example, such as where a desktop computer is used to upload a listing, the GPS coordinates may be of the location of the computer. In such an example, the items may be put out for collection at a point near to the user computer address in order for the discarded items to be found. The application or program may indicate when the GPS address has been found 94. In some embodiments, the program may automatically determine and display the GPS location of the discarded item. The automatic determination and display may be triggered by the upload of a listing of a discarded item by a user. The automatic determination of the GPS may be triggered by taking a photo of the item/s. Any suitable input associated with the upload may trigger the GPS determination and display. The application or program may display the inputted address, the GPS address or the inputted address and the GPS address 96 as in the example shown in FIG. 9b. The GPS coordinates may be displayed as an address. The address may be displayed with the listing. The address may be used to facilitate an order of displaying the listings. The address may provide a way of searching according to a geographical location. The address may include, but is not limited to the country, city, neighborhood, street name, number of house/s or building/s, postal code, map and GPS coordinates. The address may only include the street name and a specific or general location in the street.

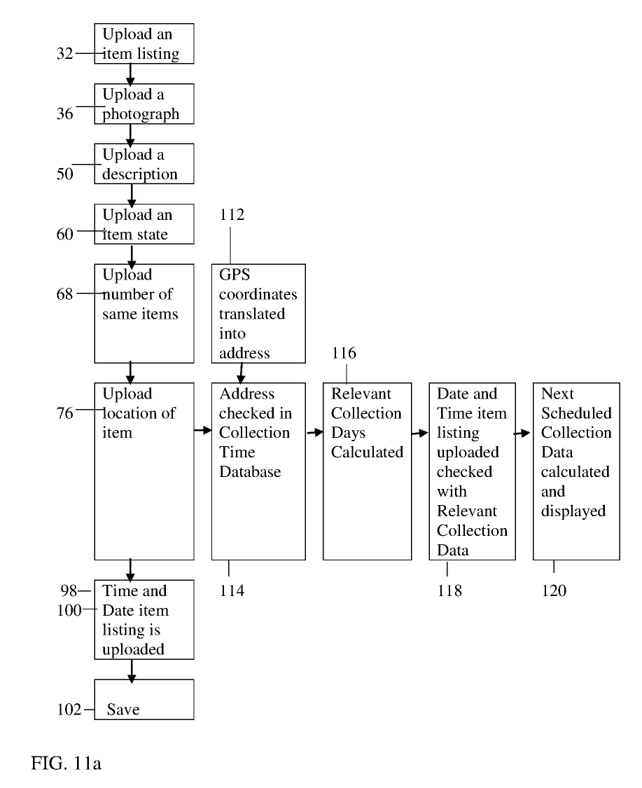

The program may include a clock and the time 98 and the date 100 when a listing of an item is uploaded may be determined and recorded as in the non-limiting example shown in FIG. 10. The time 98 and the date 100 may be determined and recorded automatically by any suitable input associated with the upload of the listing of the item. The time and the date may be displayed with the listing. The date and the time the item listing is uploaded may be used to facilitate an order of the displayed listings. The GUI may provide and display the listings according to the date and the time the listing was uploaded with non-limiting options of showing the newest items first or the oldest items first. The date and the time may be used to update the database. At a predetermined interval after the date and the time for collection have lapsed, the collection listings with a date and time earlier than that collection date and time, which should have been collected by a collection service may be deleted or may be moved from the current listings and stored in a different place, such as but not limited to in an archive.

As shown in FIG. 2 when a user had finished uploading a listing of a discarded item, the user may select an uploading module for the option of saving and uploading the listing to the database 102. When this option is selected the listing is uploaded and can be displayed by the system. In some embodiments, the listing may be uploaded without the user selecting the save option. A user may be provided with at least one of the following selection options: to exit the program 104, to upload an additional item listing 106 or to search for an item 108.

In some embodiments a plurality of different items are being discarded by the same user. The different items may be discarded at the same location. Each different item may be uploaded as a separate listing or in one listing. For example, a customer throwing out a couch and a painting may upload a photo of the couch and a photo of the painting in the same listing or in separate listings. Each item of a plurality of different items thrown out by a user at the same place may be uploaded under the same address. When the user has completed inputting a listing of a first discarded item, the user may be given the option to input and upload a listing of an additional item 106 as shown in FIG. 2. In such an embodiment, the user may repeat the method 32 described hereinabove. The user may exit the program at any time.

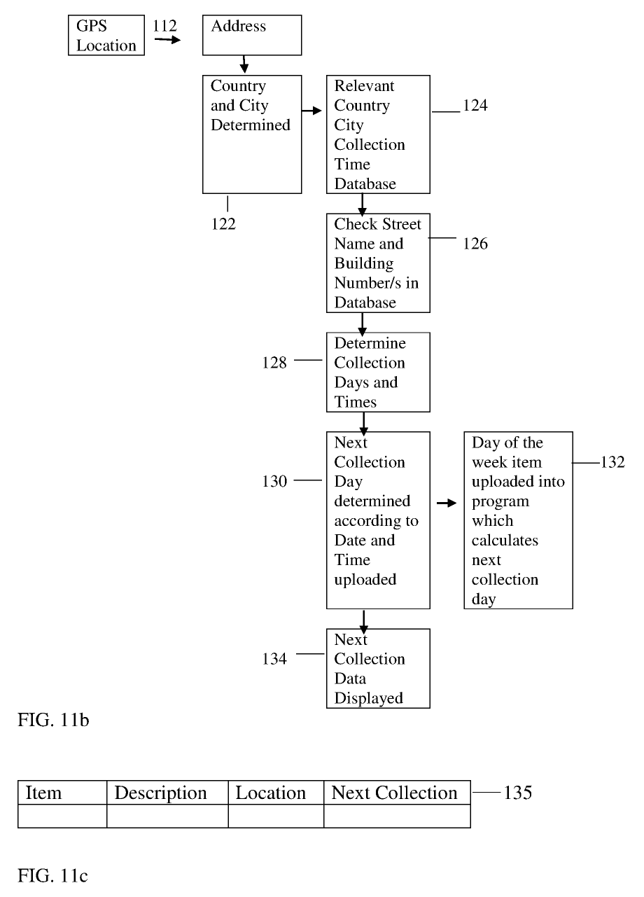

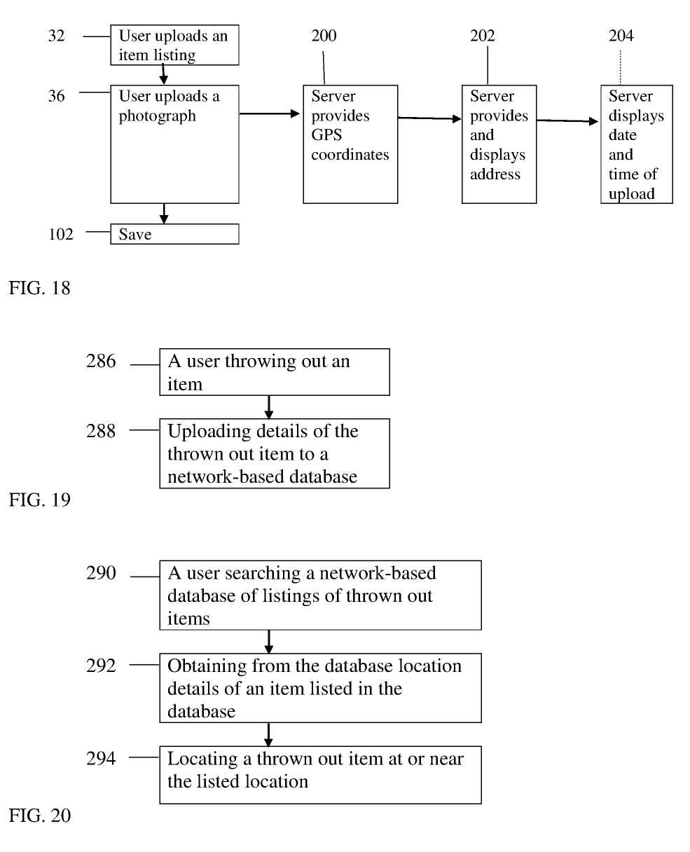

In one aspect, as shown in FIG. 18, the upload of a listing may include a user entering the program of the present invention, the user selecting an uploading option to upload a discarded item listing 32 and the user uploading a photograph of the discarded item/s 36. The application server may calculate, provide and display at least one of the GPS address of the location of the discarded item 280 according to the GPS location of the communication device used by the user to upload the listing at the time of uploading the listing, the geographical address 282 and the date and the time the item is uploaded 284. A description of the discarded item may be provided by any suitable available computer method of enabling a description or categorization of objects from a photograph. In some embodiments the user may use a description module of the uploading mechanism of the database of the present invention to input a description. The application server may also determine, calculate, provide and display the collection times of discarded items according to the discarded item's address and when the items were uploaded as shown in FIG. 11a and FIG. 11b and as described herein. The listing may be uploaded to the database by the user selecting an upload option. In some embodiments, exiting the program/application may cause uploading of the listing. Such an upload as is described in FIG. 18, which features less steps for a user is more facile and less time consuming for a user.

The methods shown in FIG. 2 and FIG. 18 may be repeated by any number of users at a plurality of locations to facilitate creating a searchable network-based database of thrown out items. The order of the steps of the methods is not limited to that shown in the figures or described herein and the steps may be performed in any suitable order. The method of uploading a listing of a thrown out item may include all or only some of the steps shown in FIG. 2 and FIG. 18 and described herein. A user may be offered incentives to provide comprehensive data relating to the item/s thrown out. For example, when a user inputs data relating to the condition of the item/s, item material and detailed description, the user may receive points or coupons which can be used to obtain benefits. Each inputted and uploaded item listing may be associated with a reference number. The database, such as the network-based database may include a plurality of listings featuring each of the uploaded listings of items. The plurality of listings may be of items thrown out by a plurality of users at a plurality of locations. The modules may be communicatively coupled and may provide information to and receive information from other modules.

FIG. 19 shows a method of discarding an item according to an aspect of the present invention. A user may throw out an item 286. The item may be any suitable waste item, which may include a non-regular waste item, such as, but not limited to a bulky item and/or a non-binned item. Non-limiting examples of suitable waste items may include household items, bulky items, furniture, cupboards, tables, chairs, sofas, beds, desks, shelves, fences, mattresses, fridges, ovens, gas burners, washing machines, dryers, dishwashers, sinks, toilets, doors, umbrellas, clothes horses, baskets, books, clothes, crockery, cutlery, bicycles, scooters, games, tents, swings, toys, appliances, electrical devices, electronic devices, office furniture, office equipment, computers, printers, televisions, paintings, art, telephones, radios, heaters, carpets, flooring, baths, taps, gardening accessories, paint, mirrors, wood, metal, household items, home fixtures, sports equipment, gardening items and plants. The user may upload details of the thrown out item to a listing in a network-based database 288 as described herein. The network-based database may be a web-based database. The network-based database may be a searchable database. The database may be searchable by users, including users who have thrown out items and users who have not thrown out items.

FIG. 11a is of an exemplary method of creating a database, such as a network-based database of discarded items with collection times 110 according to an aspect of the present invention. The GUI may provide a user with the time and/or the days of collection services according to the location of the item. Collection services may include, but is not limited to any suitable waste, rubbish or recycling collection service such as municipal or state collection services and private collection services. In some countries, such as, but not limited to Israel, collection services are provided by the municipality. The municipality may use municipal employees, or may use the services of an external collection provider. In some countries the municipality service does not cost a person directly and may be paid through the city rates. In other countries, collection services may be provided for a fee and collection may be arranged between the collection service and the item's owner. In some countries, you may be liable for a fine if you throw out waste, such as throwing out non-regular waste onto the street either on a day when it is not allowed or at any time in non-designated places. The program or application according to an aspect of the present invention may be configured to calculate and or display the collection times of discarded items according to a location. The inputted address and/or the GPS coordinates of the location of the discarded item may be used in the calculation. The GPS coordinates may be converted into a geographical address 112. Any suitable program may be used to provide such a conversion. The address is checked in the collection time database 114 and the relevant collection days are determined 116. The collection time database may be one or a plurality of databases. For example the program of the present invention may be linked to the collection time databases, which may be electronic, of cities, municipalities and towns of a country which have such waste collection databases. Alternatively, or in addition, the waste collection day and time information of a city, town or country may be collected and stored in a database of the present invention. The date and time the item listing was uploaded is then checked against the relevant collection days and times applicable to the address 118 and the next collection day and time is determined 120. The program of the present invention may calculate and display the next collection day according to the date and time the item is uploaded.

FIG. 11b shows an exemplary method of creating a database, such as a network-based database of discarded items with collection times in accordance with an aspect of the present invention. The system includes information relating to collection times of waste items, which may include non-regular waste items. The information may be inputted manually into the database of the present invention. Alternatively, the database may be linked to internet sites containing the relevant information. Cities which have such a municipal collection service may have an internet site which displays the days and/or times of pickup from each street of the different categories of rubbish, including, but not limited to recycling waste and non-regular waste. As shown in FIG. 11b when an item listing is entered and uploaded in the database of the present invention, the GUI automatically checks the relevant location information, such as, but not limited to street name, city name and country name. The relevant country and city may be determined from the address 122. The relevant collection time database for the country and city may be found 124. The street name and number of the nearest buildings may be determined from the address and this may be checked in the relevant city collection time database 126. The collection days and times relevant to the location may be determined 128. The next collection day may be determined according to the date and the time the item listing was uploaded 130. The date and time that the item listing is uploaded may then be checked with the collection days and times relevant to the location, resulting in determination of the next scheduled collection day 132. In one non-limiting method, the day of the week corresponding to the date of uploading may be identified. The day of the week may then be checked with the collection days. When the day of uploading is not a collection day, the collection day may be calculated as the next due collection day after the day the item was uploaded. When the day of uploading the item is the same as the collection day, the time of uploading may be checked against the time of collection. When the time of collection is later than the time the item was uploaded, the collection day may be displayed as the day the item was uploaded. When the time of collection is earlier than the time the item was uploaded, the collection day may be displayed as the next due collection day after the day the item was uploaded. The next collection day determination may be done using a computer program/algorithm according to an aspect of the present invention. The resulting next scheduled collection information may then be displayed 134. The next scheduled collection data, such as the day and/or time may be saved with the item and can be displayed in a suitable place with the item information 135 as schematically shown in FIG. 11c.

An algorithm may use the identified GPS location of the thrown out item to ascertain from a database of collection days, the collection day/s associated with the identified address. The algorithm may identify the day the item was thrown out and may check this data with the collection day/s in order to calculate which of the collection days is the next collection day at that address. When the collection day is the same as the day that the item was thrown out, the algorithm may check that the time the item was thrown out is before the estimated time of the collection and may amend the next collection day accordingly.

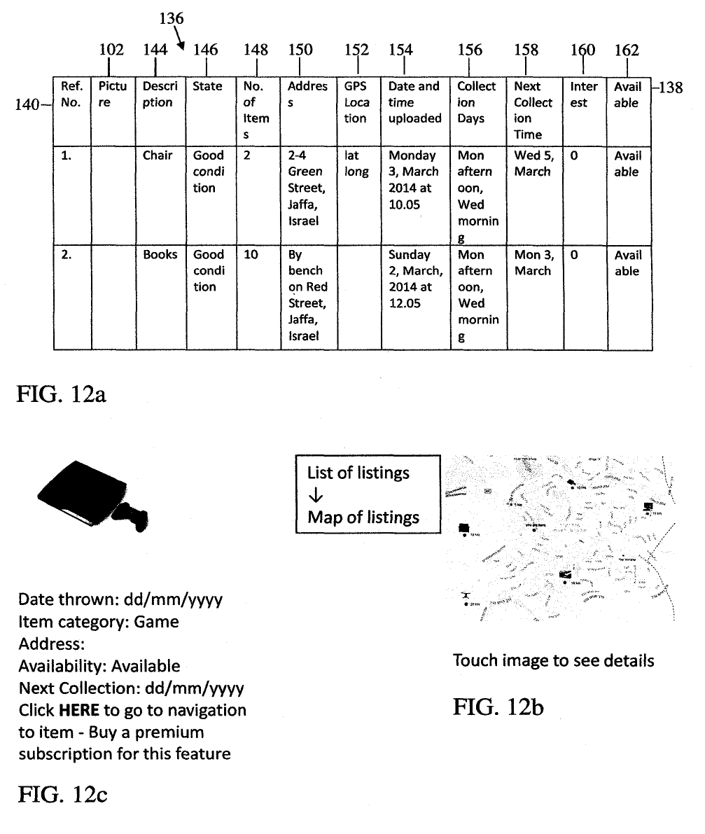

FIG. 12a shows a schematic representation of an exemplary display of listings of thrown out items 136 according to an aspect of the present invention. In FIG. 12a, the items are listed with the newest uploaded item 138 listing listed first. However, the user can change the order according to a plurality of parameters, such as, but not limited to, time uploaded, time before pick up, proximity of the location to the user, alphabetical order, state of the item, item category and a combination thereof. Each listing may include information which may be displayed under modules or descriptive headings. The information which may be displayed may include, but is not limited to information relating to the following modules or descriptive headings, such as, a reference number 140, a photograph of the item 142, a description of the item 144, a state of the item 146, the number of same items 148, the location of the item, such as, but not limited to the address of the item 150, the GPS coordinates 152, the date the item listing is uploaded 154, the time the item listing is uploaded 154, the collection service times 156, the next collection service time 158, the number of users interested in the item 160, and the availability status 162. The date and time an item was put out on the street may also be displayed. The listings may be displayed in any suitable order, way and format. The listings may employ different colors to clarify and simplify the displayed information. The listings may be displayed on a map as shown in FIG. 12b. The listings may appear as icons or images or highlighted points or any suitable markings on the map. A user may be able to click on or activate the icon or other type of marking indicating an item on the map. Selecting a marked item on the map, by for example clicking at the position on the map may result in a display of information relating to the item as shown in FIG. 12c. The listings may be saved, copied and printed.

A listing may be displayed for any suitable length of time. The listing may be displayed up to the end of the day a collection service is scheduled to pick up the item. The listing may be displayed after the first collection time from when the item is placed on the street has lapsed. The listing may be displayed for at least one day after the collection service is scheduled to pick up the item. In some embodiments, the listing may be deleted from the available listings, or the status changed and the item displayed as taken on the day after the scheduled collection time. A collection service may update the status of the listing as ‘taken by collection service’. Updating the status as taken by a collection service may only be enabled to a collection service user. A user may be able to view a display of recent listings, including listings which have been verified as taken and listings after the respective collection day.

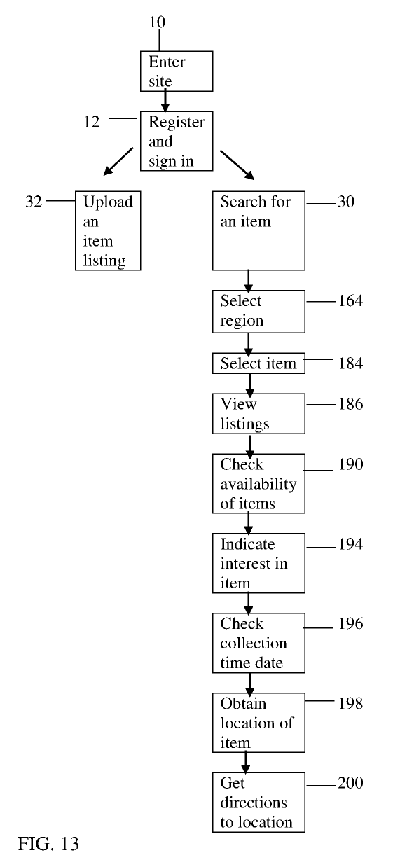

FIG. 13 shows a flow diagram of an exemplary method of providing and displaying listings of discarded items to a user searching for an item in the database, such as the network-based database according to an aspect of the present invention. As shown in FIG. 13, a user may enter the program/application 10 of the present application. The program/application may be available via an internet site or by a mobile or communication application. The user may download the site or application. The user may have to register 12. Registration may be subject to a fee. In some embodiments, a user searching for an item may be charged a fee, whereas a user uploading items may not be liable to pay. A user may have to sign in or log in to the program/application and when the user enters the program/application, the graphic user interface (GUI) may provide the user with options such as the option to upload a listing of an item 32 or to search for an item 30. The options may be provided in a menu or on a landing page or in any suitable place. A user who wants to search for an item may select the search option 30. The page may automatically display items near or within a certain radius of the user as indicated by the GPS position of the mobile device, or other location information relating to the user. The GUI may then display search options.

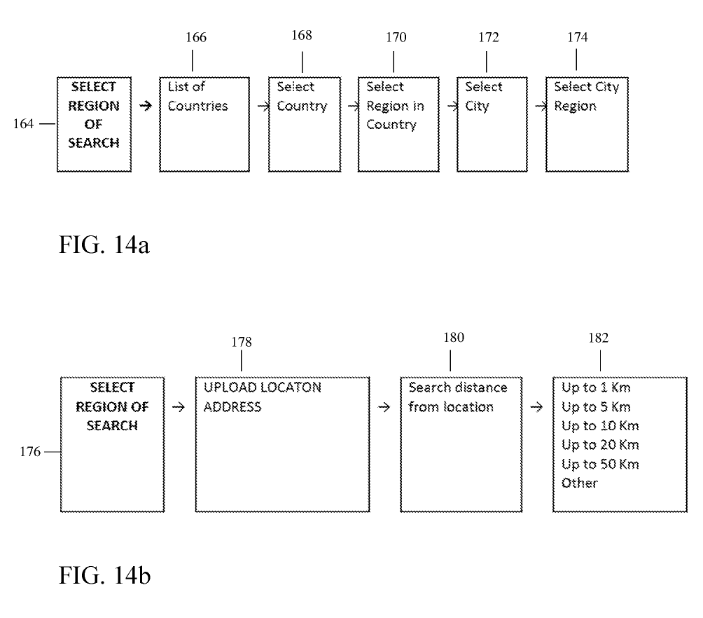

A first search option may include selection of the region of the search 164 in which the user would like to search as shown in FIG. 14a. The search region may have sub search features. The search region option may provide a list of countries 166. The user may select at least one country 168. A version of the networked system of the present invention may be customized according to a specific geographic region. A user may select a region or zone within a country 170. A user may select at least one city 172. A user may select a region, a neighborhood, or an area within a city 174. A user may select one region, several regions or all regions. In some embodiments the application/program may automatically select the search region according to the GPS location of the mobile device of a user, or stored location information relating to the user. The application/program may select the search region according to the type of application the user has, such as a basic, or premium application. Alternatively, or in addition a user may search according to a distance or radius from a certain location 176 as shown schematically in FIG. 14b. In such an embodiment, a user may select or input a location 178 and then select the option of searching according to the search distance from the location 180 and select the size or radius of the search area according to the distance from the location 182.

Returning to FIG. 13, once a user has selected the search region or the application has automatically selected the search region, the user may select at least one item 184 he is searching for or may view all items. Alternatively, a user may select the item he is searching for first and then select the geographical search region. The GUI may provide categories of grouped items in the search options, such as, but not limited to furniture; electronic goods; clothes; books; gardening items; gardening waste; games; exercise; accessories and miscellaneous. Each category may include subcategories of items. The user may select at least one of these categories and subcategories. The GUI may also or alternatively provide the user with the option of typing a specific item and searching the database for that item. The GUI may provide a user with the search results of listings as shown schematically in FIGS. 12a, 12b and 12c. As described for FIG. 12a, the listings may be in any suitable order and may include information relating to the item.

A user may have the option of searching for items, which are no longer available. A user may conduct such a search to assess, which items are more frequently available and where such items are more likely to be found. A user may want to create or look at different search statistics using this information. In some embodiments, a user may be provided with access to additional navigation features, programs or applications to supplement the search.

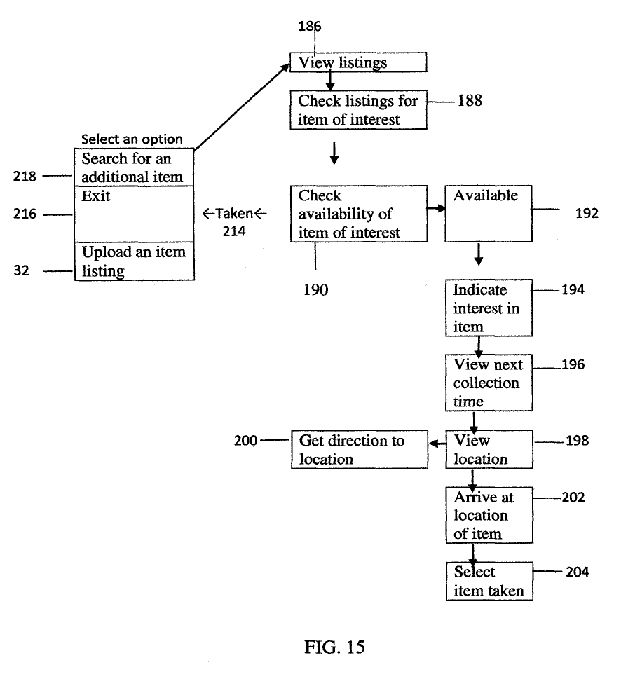

FIG. 15 shows an exemplary method of a user finding an item and picking up and obtaining the item according to an aspect of the present invention. A user may follow the method described in FIGS. 13-14 and may be provided with listings of discarded items. The user may view the listings 186. The user may change the search terms and check the listings until he finds an item of interest 188. The listing may include an availability status. Non-limiting examples of availability status may include available, taken, taken by searcher, taken by collection service and unknown. For an item of interest, the user may check the availability 190. When the item is displayed as still available 192, the user may proceed with the process in order to obtain the item.

A user may optionally select an option to indicate that he is interested in an item 194. The GUI may provide the user with the option of selecting ‘interested in the item’. The GUI may provide the user with the option of inputting contact details or relevant identification details. Indicating interest may provide another user with an indication of the chance of an item being available and an estimate of how many people are interested in the item. If an interested user has included contact details a second interested user may be able to contact the first or earlier interested user/s to ascertain the intentions of the first user/s to pick up the item. The second interested user may offer to buy the item from the first user if he has already taken it or is in the process of picking it up. The indication of interest in the item information and contact details may also be used by a third party with a similar item to discard or sell.

A user may check to see when the collection service is due to pick up the respective item 196 and use this information to assess availability. The user may locate the item using the geographical location information. The user may view the displayed location 198.

The GUI may provide the user with directions of how to reach the location 200. The directions may be directions suitable for different modes of transport, such as but not limited to for a pedestrian, for driving, for cycling or for public transport. The application or program of the present invention may provide this information using a suitable navigation program/system such as, but not limited to Waze™ or IGo™. The application or program of the present invention may provide a user with a shortcut to such a navigation program.

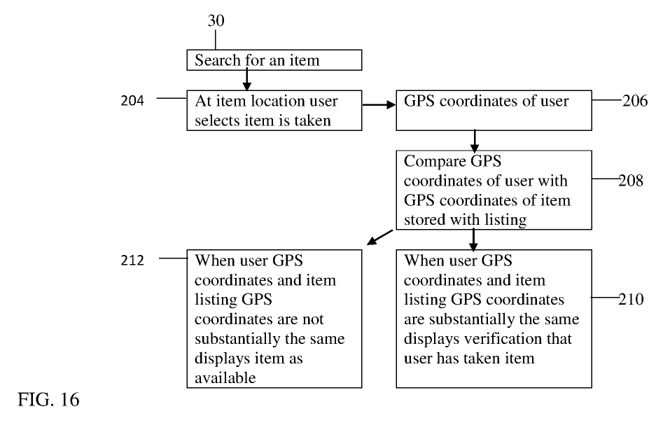

The user, or other individual, who may be appointed, may arrive at the location of the item 202. At the geographical location, the user may ascertain that the item is at the location and has not been taken. If the item is there, the user may inspect the item. A user may decide not to take the item. If the user decides to take the item, the user may select using a computer module of a searchable network-based database of the present invention on his mobile device the availability option provided by the GUI and indicate that the item is no longer available by selecting the item has been taken option 204. As shown in FIG. 16 selection of the item has been taken results in a GPS reading of the location of the user 206. The GPS reading may be the GPS reading of the mobile device of the user. The system, application or program of the present invention may compare the GPS of the location of the user with the temporary GPS location of the discarded item, which was uploaded with the item listing and stored with the listing 208. The GPS location of the thrown out item is determined by the GPS location of a user device used by a user throwing out the item to upload the listing at the time of the uploading. The system, application or program may verify that the user has picked up the item when the temporary GPS location of the user who indicates that he is taking the item/s and the temporary GPS location of the thrown out item are substantially the same 210. The two GPS locations may differ by a distance where the item is still in the line of site of a user. The distance may differ by up to about ten meters and still result in verification. In some embodiments the distance may differ up to about fifty meters and may still result in verification that the item has been taken. When the system of the present invention determines that the two GPS locations are substantially the same, the system may be configured to display with the listing that the discarded good has been taken. When the two GPS locations are not substantially the same, the application may display that the item is still available 212. In such a way, a user may not falsely indicate that an item has been taken, in order to prevent other users from taking the item before him, or for any other reason. When a user takes an item, the item will move, resulting in the GPS location of the thrown out item changing. The user will also move resulting in a change of the user's GPS location. The present invention may encourage a user to indicate an item has been taken when the user takes the item. Non-limiting examples of such encouragement means may include providing credit to a user for use with the program or application of the present invention or another program or application. In some embodiments, when users of the present invention pass by any listed items, they may receive a notification, such as on a mobile device, requesting confirmation of whether an item is still available. Such a crowdsourcing method may ensure the availability of items in the database is more optimally updated.

In some embodiments, when a thrown out item is taken by a user, a message may be sent to the user who threw out the item, informing him that the item was taken. The message may thank the user. Such a message may be an incentive for a user to continue to use the application of the present invention as a method to throw out non-regular, reusable waste. The message may be sent to the mobile device of a registered user and/or to a social media site of the user.

Returning to FIG. 15, when an item of interest is not available, such as it has been taken 214, a user may select at least one of the following options. The user may exit the program/application 216. The user may conduct an additional search or return to the search results and check a different item listing 218, wherein the method for these searches may be as described hereinabove. The user may select to upload a listing of an item 32 and proceed as described hereinabove. In some embodiments, exiting the application/program may result in automatic uploading of a listing. A user may also have the option to request notification when a specific item listing is uploaded (not shown in the figure). Notification may be through any suitable means, such as, but not limited to using messaging, Email and social media sites.

FIG. 20 shows a method of finding at least one thrown out item according to an aspect of the present invention. The method may include a user searching a network-based database of thrown out items 290. The method may feature the user obtaining from the database location details of an item listed in the database 292 and the user locating the thrown out item at or near about the listed location 294.

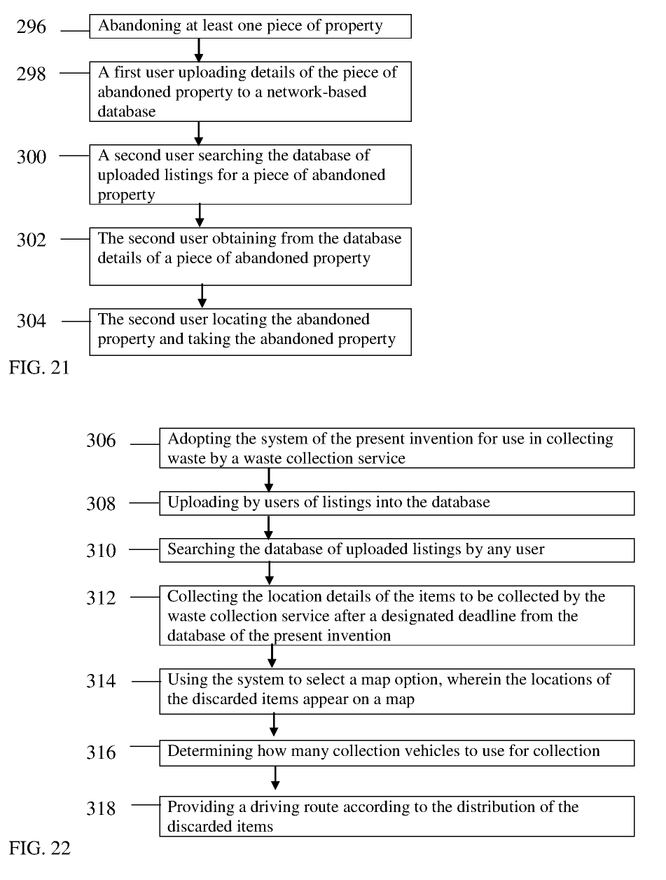

FIG. 21 shows a method of obtaining abandoned property according to an aspect of the present invention. The method may feature a user abandoning at least one piece of property into a space for collection 296. The method may include a user uploading details of the piece of abandoned property to a network-based database 298. The user may be the owner of the abandoned property or may not be the owner. In some embodiments, a user may find abandoned property and may upload a listing with details of the abandoned property he has found. This type of crowdsourcing facilitates optimization of the database to include listings of a maximum number of abandoned items. The method may feature a second user searching the database for a piece of abandoned property 300. The method may include the second user obtaining location details of a piece of abandoned property from the database 302. The method may feature the second user locating the abandoned property and taking the abandoned property 304.

A user may be able to copy or print the displayed information at any suitable time during the search. A user may exit the program or application at any suitable time.

The present invention may be provided as a computer program product which may include a machine-readable medium having stored thereon instructions which may be used to program a computer (or other electronic devices) to perform a process according to the present invention. The computer readable instructions of a computer readable storage medium may cause a computing device to perform actions. Actions may include transferring a request to view listings of discarded items associated with a geographical area, determining collection service collection times of discarded items relating to the location of an item in the listings, displaying to a requesting user the next collection time of an item relative to the date and time the item listing was uploaded to the database, enabling the user to view the listings and the determined collection time and a combination thereof.

The machine-readable medium may include, but is not limited to floppy diskettes, optical disks, CD-ROMs and magnetic-optical disks ROMs, RAMs, EPROMs, EEPROMs, magnetic or optical cards, or other types of media/machine readable medium suitable for storing electronic instructions. Moreover the present invention may also be downloaded as a computer program product, wherein the program may be transferred from a remote computer (e.g. a server) to a requesting computer (e.g. a user) by way of data signals embodied in a carrier wave or other propagation medium, such as from the Internet via a communication link (e.g. a modem or network connection).

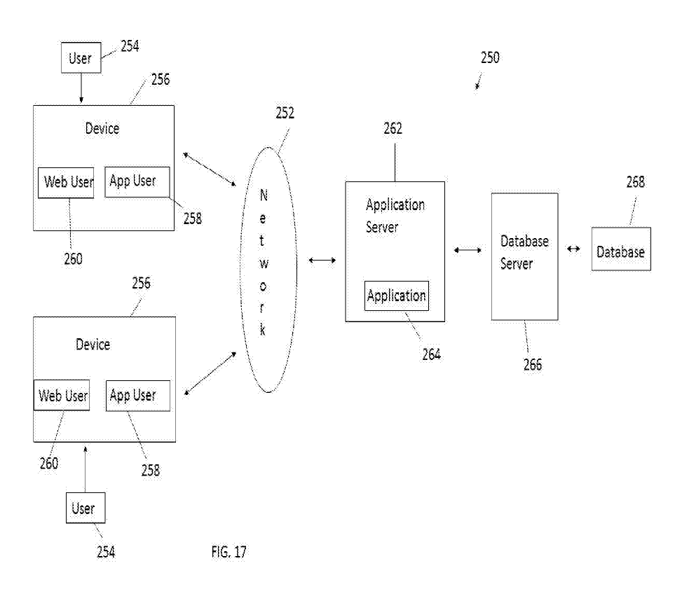

FIG. 17 shows an exemplary system 250 for providing a network based database of listings of discarded items according to some embodiments. A networked system 250 provides server functionality via a network 252 to a least one user 254 and at least one device 256. Non-limiting examples of suitable networks 252 include the internet, Intranet or Wide Area Network (WAN). Each device 256 may include at least a display and communication capabilities with the network to access the networked system. Non-limiting examples of suitable devices 256 include work stations, computers, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs and mini-computers. Each of the devices 256 may connect with the network 252 via a wired or wireless connection or a combination thereof. A device 256 may include the discarded item listings and search application according to an aspect of the present invention, such as provided to an app user 258, which may be in the form of a self-contained program or piece of software designed to provide the discarded item listing and search functions. In some embodiments the application is configured to locally provide the user interface and at least some of the functionalities with the mechanism configured to communicate with the networked system on an as needed basis for data and/or processing capabilities not locally available, such as for example access to a database of available discarded items. Conversely, if the discarded item application mechanism is not included in a device, such as for a web user 260, the device 256 may use its web browser to access the discarded item mechanism hosted on the networked system. At least one device 256 may be included in the system 250. An Application Program Interface server (not shown in FIG. 16) and a web server (not shown in FIG. 16) may be included in the system and may be coupled to and provide programmatic and web interfaces respective to at least one application server 262. The application server 262 may host the discarded item listing and search database application 264. The application server 262 may host additional applications. The application server 262 may be coupled to at least one database server 266 that facilitates access to at least one database 268.

The application server 262 may be associated with a plurality of communication devices 256 and may be configured to receive from the plurality of communication devices 256 listings of discarded items and the respective geographical address for locating the discarded items. The server 262 may present listings of discarded item/s to users, wherein each listing includes a geographical address for locating the discarded item/s and the collection times of discarded items associated with the geographical location of the listing. The server 262 may be configured to determine when the pickup collection times are according to the geographical address and to display with the listing the next collection time according to the geographical address and the date the discarded item is uploaded onto the database.

The discarded item database application may provide a number of functions and services to users that access the networked system as described hereinabove. Additional functions and services, which are not described hereinabove may also be provided to users by the database application of the present invention. A web user may access the discarded item database application via the web interface supported by the web server. Similarly, a programmatic application user may access the functions provided by the application via the programmatic interface provided by the Application Program Interface server.

The discarded item database application of the present invention may communicatively couple with at least one additional application and data source in order to allow information to be passed between the applications or to allow the applications to share and access common data. The application of the present invention may access one or more databases via the data servers.

The searchable database of the present invention may have a plurality of uses. One exemplary use is to provide solutions to municipal, private or other rubbish collection service providers. Items, such as furniture, clothes, household items, office items, bulky waste, electrical appliances etc. which may not be included in the regular designated waste containers, may be collected separately from other waste and may be collected at different times and with different frequency than regular waste. Such items are not usually thrown out by each household or each business at each collection time. As such, the municipal or other collection service vehicles do not need to stop at each household or business on the days that they collect this type of waste. Methods of collecting this non-regular waste include driving through all the streets until waste is identified and/or a person checking streets for waste and then notifying the collection vehicle of its location. These methods have many disadvantages. They are time consuming, create unnecessary pollution and road congestion, do not optimize manpower or vehicles in use and may not be effective in locating all the discarded waste. It would be advantageous for the collection vehicles to drive according to a map of the locations of non-regular waste waiting for pick up. The network-based database of the present invention may be used by the population serviced by the waste collection service. In such a way, each user of the population may upload a listing of the item/s of waste he discards into a collection space. The collection service may have a day and/or time deadline for when a listing can be uploaded for next collection. The system of the present invention may provide the uploaded listings in a map of the area, which may include roads and streets and the locations of the items to be collected. The uploaded listings and related information may be used by the collection service to ascertain a route to collect the listed waste. The route map may be an approximation, determined by for example, but not limited to avoiding areas where no listing of waste has been uploaded. The route map may be constructed manually and/or electronically. The route map may be constructed using the uploaded data with a program, such as a program which takes into account traffic. Accordingly, use by the collection service of the data from the database of the present invention may result in a collection vehicle not needing to check irrelevant streets for items to be collected, facilitating a quicker collection time for the collection service. A shorter route may result in less vehicles being needed, less workers employed, less fuel used and reduction of pollution from the collection vehicles.

Some collection services pick up non-regular waste, which includes items of potentially more interest than others for reuse and for recycling and reuse by the general public, such as garden waste. The system of the present invention may provide a selection option for users when uploading waste items to differentiate between certain discarded items/waste, such as for example garden waste or equivalent and other items. This may simplify searching of the database for items of interest.

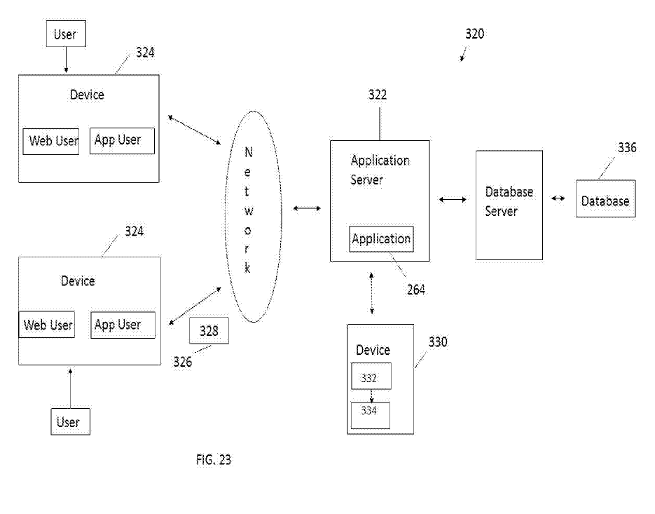

FIG. 22 shows an exemplary method of use of the searchable network-based database of thrown out items of the present invention. A waste collection service may adopt the system of the present invention 306 for use in collecting waste, such as non-regular waste as herein described. The waste collection service may instruct the population it services that when they throw out an item into a space suitable for collection by the service, a listing of the item should be uploaded by a user to the database of the present invention. In some places, there may be designated days and times in which such items can be thrown out and times and days when the collection service picks up such items. Users may upload listings of items into the database, by any suitable way as described herein 308. The database of uploaded listings may be searched by any user as described hereinabove 310. When an item is located and collected by a user, the availability of the listing may be updated by the user. After a designated deadline, the collection service may collect or receive the location details of the items to be collected 312 from the database of the present invention, such as the items which are displayed to still be available. The system of the present invention may be configured to provide this data to the waste collection service. The system of the present invention may be configured to provide a map with the location details of waste to be collected. The method of collecting waste may include locating and collecting the thrown out items according to the map, where the map may include the location details of the thrown out items from listings of the thrown out items uploaded by the plurality of users to the database. The map may be created to include the plurality of locations, which are within a defined area. The map may be created after a predetermined time and may include listings of thrown out items which are displayed as available at or after the predetermined time. The collection service may use the present invention to select a map option, wherein the locations of the discarded items appear on a map 314. The present invention may provide a method of at least one collection vehicle collecting a plurality of non-binned waste at a plurality of locations in a collection area. The listings may include a location and an image of the waste uploaded by users before the predetermined time. The collection service may determine how many collection vehicles to use for collection, according to the amount of listed discarded items and/or the geographical distribution of the discarded items 316. Alternatively, or in addition, the system of the present invention may calculate at least one of the number of vehicles, number of workers, fuel and costs for collecting the discarded items/waste according to the listings in the database. The present invention may provide a driving route according to the distribution of the discarded items 318. The location information may be used with any suitable route planner program and/or navigation system.

FIG. 23 shows an exemplary system for collecting rubbish. The system may provide a user, such as a collection service provider with a plurality of locations of items to collect. The system 320 may include an application server 322 associated with a plurality of communication devices 324. The application server 322 is configured to receive from the plurality of communication devices 324 data, which may include listings of discarded goods 326 and the respective geographical address 328 for locating the discarded goods. The thrown out items may not be in a bin or may not be associated with a bin. The application server is configured to receive updates regarding the availability of the listings of the discarded goods. The application server may be configured to provide and display the plurality of locations of the discarded goods, which are displayed as still available at a defined time, which may be after a deadline or other specific time. The application server may present to a rubbish collection service provider or related organization after a defined time before collection, the plurality of locations of the discarded goods which are displayed as available at the defined time before collection. The locations may be provided to a device of the rubbish collection service provider or related organization. The application server may provide the locations as a list, which may include addresses and/or the roads where there is waste to collect. The application server may provide the locations on a map of the area 332.

The map may be constructed by any suitable method. In one non-limiting example at a defined time, a program of the present invention may check the database and identify a listing as available or taken. The program may also check the database for listings within a defined geographical area. When a listing is within the defined geographical area and is available the map may be marked at the location of the item/s. When a listing is not available it may not be marked on the map. This method may be repeated for all the listings uploaded before a predetermined time.

In some embodiments, the application server may employ a program to calculate a route to pick up the discarded goods 334 and the route 334 may be provided to the user, such as the collection service provider. The route 334 may be calculated according to parameters, such as for example minimal driving distance and/or quickest route. The system 320 may facilitate a method of collecting items of rubbish by locating and picking up the items of rubbish according to the map of locations 332 and wherein the details of the items are uploaded 326 by at least one user to a network-based database 336.

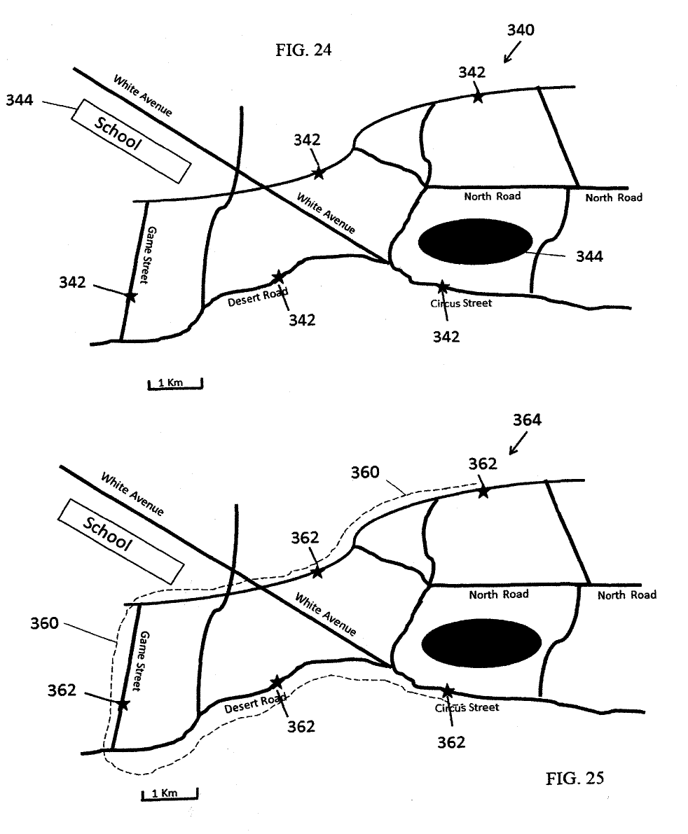

FIG. 24 shows an exemplary map of locations of items for collection. As shown in FIG. 24, a map 340 may include a plurality of locations 342 of items for collection. The locations of the items may be determined according to details of the items uploaded as listings by at least one user to a searchable network-based database. The items for collection may have been thrown out and may be located outside. The thrown out items may not be in bins. The location may be of items, which are displayed as available in the listings. The map may include thrown out items with unknown availability or thrown out items which are not available. The map 340 may include roads, streets and other landmarks 344. T Non-limiting examples of other landmarks 344, include pavements, parks, letterboxes, benches, shops, bus stops, car parks, places of interest, schools, shopping centers, offices, streetlamps, rubbish bins, universities, libraries, cinemas, theatres, gyms, swimming pools, tennis courts, basketball courts, football fields, synagogues, churches, mosques, cemeteries, ice skating rinks, museums, hospitals, surgeries, parking lots, bus stops and stations. Details of the proximity of items for collection to the other landmarks 344 may make locating items for collection more facile.

FIG. 25 shows an exemplary route for a waste collection vehicle, according to an aspect of the present invention. As shown in FIG. 25, a route 360 may feature a plurality of roads and a combination of roads. The route is determined according to a plurality of locations 362 of a plurality of items for collection, which may be displayed as available at or after a defined time and a map 364. The items have been uploaded as listings to a searchable network-based, network-based database by at least one user or a plurality of users. The route 360 facilitates access to the items at each of the plurality of locations 362 for collection of the items. The route 360 may be calculated according to many factors, such as, but not limited to shortest distance, shortest driving distance or quickest way, the number of available collection vehicles, the number of workers and the number of work hours.

Reference is made to the following examples, which together with the above descriptions illustrate the invention in a non-limiting fashion.

### EXAMPLE 1

A user upgrades his television and throws out his old television onto the street. The user has downloaded an application of the present invention onto his mobile phone. The user opens the app and in the menu selects the uploading a listing option. The user takes a photograph of the discarded television on the street and uploads the photo onto the application site. The user is then instructed to select a location option. The application uses a GPS to identify the location of the discarded item by assuming that it is the same as the GPS of the user device being employed to upload the listing and displays the address. The app uses the address to determine when the next municipality collection day is and this information is displayed on the app site with the listing of the television. The user is provided with a select the state of the television option. From the options provided the user chooses ‘in working order’. In the number of items selection, the user inputs ‘1’. The listing is uploaded.

### EXAMPLE 2

A user has downloaded an application of the present invention. The user opens the application and selects the seeking option. The user selects the geographical area in which he is interested in seeking. The user selects the city of Modi'in. The user then selects the entire city as the part of the city he is interested in searching. The application displays listings of discarded items. The user is seeking a washing machine. The searching user uses the search feature to search for a washing machine. The application displays one listing. The listing includes the location of the washing machine and indicates that the municipality collection time is the next day. The user arrives at the location. The washing machine is there and the user inspects the washing machine and decides to take it. The user selects the no longer available option on the displayed menu. The application updates the listing to display the verification that the washing machine has been taken. The user then takes the washing machine.

### EXAMPLE 3

The municipal waste collection service of a city adopts the searchable network-based database of thrown out items of the present invention to use for collecting non-regular waste. The waste collection service provides its customers with access to a program/application of the present invention. The collection service instructs its customers to upload listings of non-regular waste to be collected, via a website, or an app of the present invention or which is connected to the system of the present invention, to which the waste collection provider has access. The waste collection provider informs the customers of the days for collection and the deadline for throwing out the waste items and uploading the listings. The waste collection provider is aware that for a particular collection day, some customers will not upload any items for collection, some customers will upload one item for collection or a plurality of the same item, and still other customers will upload a plurality of different items. After the deadline has expired, the waste collection service obtains from the system of the present invention details of the waste to be collected and the locations of the waste. The locations are provided to the collection service on a map of the area. In some instances the collection service provider determines manually the route to access all the listed waste. Alternatively, or in addition, the system of the present invention may provide the collection service with a route for the collection vehicles to pick up the listed waste. The system of the present invention calculates the number of vehicles and workers needed according to the number of listings, the areas of the thrown out items and the details of the items thrown out. The system of the present invention is configured to calculate the number of vehicles needed to pick up the items of waste according to a desired time for completion of the work.

### EXAMPLE 4

A user decides to discard his old table and throws the it out onto the street. The user has downloaded an application of the present invention onto his mobile phone. The user opens the app and in the menu selects the uploading a listing option. The user takes a photograph of the discarded table on the street and uploads the photo onto the application site. The GPS location is automatically determined and is used by the app to determine when the next municipality collection day is. The user provides a description of the item, by selecting the category ‘furniture’ from the options provided in a description module. The app determines the date and time the listing is uploaded. The photo, location, date and time of upload, description and next collection time is displayed on the app site with the listing of the table.

### EXAMPLE 5

An example of an algorithm to identify the next collection day of a discarded item.

Step 1: Identify location of thrown out item=Item address
Step 2: Item address is searched in databases of non-regular waste collection days=Non-regular waste collection days
Step 3: Identify which day item was uploaded=Thrown out day
Step 4: Calculate which non-regular waste collection day is either the same as the Thrown out day or which is the nearest day after the thrown out day
Step 5: If the Thrown out day is not equal to the nearest non-regular collection day, the next collection day is the nearest collection day after the thrown out day
Step 6: If the day the item is thrown out is equal to a non-regular waste collection day, the time the item was uploaded is compared with the time of collection. If the time the item was uploaded is after the time of collection, the next non-regular waste collection day is calculated as the next collection day. If the time the item was uploaded is before the time of collection, the same day as the item was thrown out is calculated and displayed as the next collection day.

One skilled in the art can appreciate from the foregoing description that the broad devices, systems, applications, programs, methods and techniques of the aspects of the present invention can be implemented in a variety of forms. Therefore, while the aspects of this invention have been described in connection with particular examples thereof, the true scope of the aspects of the invention should not be so limited since other modifications will become apparent to the skilled practitioner upon a study of the specification, and following claims.

1. A searchable network-based database, comprising a plurality of listings of items thrown out and awaiting collection.

2. The searchable network-based database of claim 1, wherein the items are not in a bin.

3. The searchable network-based database of claim 2, wherein the listings comprise an image of the item and a location of the item.

4. The searchable network-based database of claim 1, wherein the plurality of listings are uploaded by a plurality of users at a plurality of locations.

5. The searchable network-based database of claim 1, wherein the database is provided by a system comprising an application server associated with a plurality of communication devices to present the listings comprising thrown out item/s to users.

6. The searchable network-based database of claim 5, wherein the application server is configured: (a) to receive from the plurality of communication devices listings of thrown out items and the respective geographical address for locating the thrown out items; (b) to determine when are the pickup collection times of a collection service according to the geographical address; and (c) to display with the listing the determined collection times.

7. The searchable network-based database of claim 6, wherein the determined collection times is the next collection day relative to the date and time the thrown out item is uploaded onto the database.

8. The searchable network-based database of claim 1, wherein the database is configured to enable a user to search and view the listings of thrown out items and to obtain location information of the items to facilitate the user locating the items.

9. (canceled)

10. A system for providing a searchable network-based database of discarded items, the system comprising: an application server to present listings comprising discarded item/s to users, wherein each listing comprises a geographical address for locating the discarded item/s and the collection times of discarded items associated with the geographical location of the listing, and wherein the discarded item/s are no longer in the possession of a user who throws out the item/s.

11. The system of claim 10, wherein the application server is associated with a plurality of communication devices and is configured to receive from the plurality of communication devices listings of discarded items and the respective geographical address for locating the discarded items.

12. The system of claim 10, wherein the application server is configured to determine when the pickup collection times are according to the geographical address and to display with the listing the next collection time according to the geographical address and the date the discarded item is uploaded onto the database.

13. A method of creating a searchable network-based database of claim 1, the method comprising:
throwing out of an item into a collection space for municipal collection;
a user uploading a listing of the item, wherein the uploading comprises:
entering a program of the network-based database using a communication device.

14. The method of claim 13, comprising
selecting an uploading item listing option; and
uploading a photograph of the item; and
an application server providing information to the database relating to the item listing, comprising:
receiving the GPS address of the user device at or in close proximity to the location the item is discarded and displaying the address as the item address; and
calculating and displaying a date and time of the uploading.

15. (canceled)

16. The method of claim 13, comprising repeating the method by a plurality of users at a plurality of locations.

17. The method of claim 13, comprising displaying the item is unavailable after the next collection service collection time has lapsed, or after the item has been taken.

18-23. (cancelled)

24. The A method of claim 17, comprising verifying that a thrown out item has been taken, the method comprising:
(a) a user confirming that an item is at a location;
(b) a user deciding selecting to take the item;
(c) comparing a temporary GPS location of the thrown out item with a GPS location of the mobile device of a user taking the thrown out item and at the temporary location of the thrown out item; and
(d) verifying that the GPS location of the thrown out item is substantially the same as the GPS location of the user taking the item.

25-27. (cancelled)

28. The system of claim 11, wherein the application server is further configured: (a) to receive from a communication device of a person seeking at least one of the discarded goods the GPS address of the seeking user at the location of the at least one discarded goods; (b) to determine that the geographical address for locating the discarded goods is substantially the same as the seeking user's geographical address; and (c) to display with the listing that the discarded good has been taken when the geographical address of the discarded goods is substantially the same as the geographical address of the seeking user.

29. The system of claim 28, wherein the geographical address for locating a discarded good is the GPS location of the communication device used to upload the listing at the time the listing was uploaded.

30-45. (cancelled)

46. The searchable network-based database of claim 5, wherein the listings are presented on a map.

47. The method of claim 14, comprising a user searching the database for an item of abandoned property; the searching user obtaining from the database location details of an item of abandoned property listed in the database; and the searching user locating the item of abandoned property at the listed location.
